(19) United States
(12) Patent Application Publication
(10) Pub. No.: US 2007/0230902 A1
(43) Pub. Date: Oct. 4, 2007

(54) Dynamic disaster recovery

(75) Inventors: Sudy Shen, Richmond Hill (CA); David Ewing, Whitby (CA)

Correspondence Address: OPPENHEIMER WOLFF & DONNELLY LLP, 45 SOUTH SEVENTH STREET, SUITE 3300, MINNEAPOLIS, MN, 55402, US

(73) Assignee: Masstech Group Inc., Richmond Hill (CA)

(21) Appl. No.: 11/731,988

(22) Filed: Apr. 2, 2007

Related U.S. Application Data
(60) Provisional application No. 60/787,890, filed on Mar. 31, 2006.

(51) Int. Cl. H04N 5/91

(52) U.S. Cl. 386/83

(57) ABSTRACT

The disclosure is directed to a system and method for recovery of a broadcast source. Television data is received from the source and encoded. The encoded television data is stored by either (1) appending the encoded television data to programs on a data storage or (2) overwriting an oldest program with the encoded television data if the data storage does not have capacity to append. The source is monitored for a broadcast failure. As long as the broadcast source is operational, television data is received, encoded, and stored. Once a broadcast failure is detected, selected programs on the data storage are decoded and broadcast. This decoding and broadcasting continues until the broadcast failure at the broadcast source is repaired.

### CROSS REFERENCE TO RELATED APPLICATIONS

This application claims the benefit of U.S. Provisional Application No. 60/787890, filed Mar. 31, 2006.

### BACKGROUND

The disclosure is directed to a method and process for recording broadcast signals, such as cable television signals, onto a storage device to provide a source of program content for the broadcast system in the event of a failure within the broadcast system resulting in a loss of one or more broadcast signals. The system can be configured to replay recorded content until the problem in the broadcast system is resolved.

Broadcast system failure is a term often used to describe a technical failure that forces an unexpected halt in the transmission of programming. The technical failure can be the result of a subsystem failure at the broadcast system facility, or it can be the result of a larger or regional failure such as a loss of electricity. Broadcast system failure is a tremendous concern for operators of broadcast system facilities. Broadcast failure during commercials or sponsorships can cost the operators of the broadcast facility a considerable amount of revenue. Further, broadcast failure can cause viewers to lose confidence in the broadcast system and to switch their attention to other broadcast stations.

A system is needed to ensure continuous broadcast of scheduled programming, in the event of a broadcast system failure. In addition to providing a system for continuous broadcast of scheduled programming, it is desirable that the system not require additional staff, be non-intrusive, and be easily be integrated into the existing broadcast system.

### SUMMARY

This disclosure relates to a system for providing dynamic recovery for a broadcast facility in the event of a technical failure that leads to a disruption of programming. The disclosed examples include several advantages. Among these advantages is a system that provides continuous broadcast of scheduled programming in the event of a broadcast system failure. In addition, the system does not require additional staff, is non-intrusive, and can easily be integrated into the existing broadcast system.

In one aspect, the disclosure is directed to a method for recovery of a broadcast source. The method includes receiving television data from the broadcast source and encoding the television data. The encoded television data is stored on a data storage by either (1) appending the encoded television data to programs on the data storage if the data storage includes capacity to store the encoded television data, or (2) overwriting an oldest program with the encoded television data if the data storage does not have capacity to append. The broadcast source is monitored for broadcast failure. As long as the broadcast source is operational, the method continues to receive television data, encode the television data, and store the encoded television data until broadcasting failure is detected. Once a broadcast failure is detected, the method decodes a selected program on the data storage and broadcasts the selected program. This decoding and broadcasting selected programs on the data storage continues until the broadcast failure at the broadcast source is repaired.

In another aspect, the disclosure is directed to a system suitable for recovery of a broadcast source. The system includes a data storage device, an encoder/decoder module, an interface, and a system controller. The encoder/decoder module includes encoder and decoder circuit boards and is coupled to the data storage device. The encoder/decoder module selectively receives and encodes television data into a selected format to create encoded television data, and presents the encoded television data to the data storage device. The interface receives selected inputs provided to the system including information related to a broadcast failure at the broadcast source. The system controller is coupled to the encoder/decoder module, the data storage device, and the interface. The system controller monitors data flow through the encoder/decoder module, organizes the storage of data within the storage device, and receives inputs from the interface. Upon the broadcast failure, the system controller effects a system mode change such that selected encoded television data on the storage device is decoded in the encoder/decoder for broadcast until the broadcast failure is repaired.

### BRIEF DESCRIPTION OF THE DRAWINGS

FIG. 1 shows an example recovery system of the present disclosure.

FIG. 2 is a more detailed view of an example of the recovery system of FIG. 1.

FIGS. 3a and 3b are schematic illustrations of example data structures within an example of the system of FIG. 1.

FIG. 4 is a flow chart illustrating an example method of the system of FIG. 1.

### DESCRIPTION

This disclosure relates to a system for providing recovery for a broadcast television facility in the event of failure that leads to a disruption of the transmission of programming. The disclosure, including the figures, describes the system with reference to illustrative examples. Other examples are contemplated and are mentioned below or are otherwise imaginable to someone skilled in the art. For example, the term television should not be construed to mean only analog or digital broadcasts through typical transmissions such as off-air, cable, and satellite. Rather, the term television can include any transmittable video including video available from websites, Internet protocol television (IPTV), and others. The scope of the invention is not limited to the few examples, i.e., the described embodiments of the invention. Rather, the scope of the invention is defined by reference to the appended claims. Changes can be made to the examples, including alternative designs not disclosed, and still be within the scope of the claims.

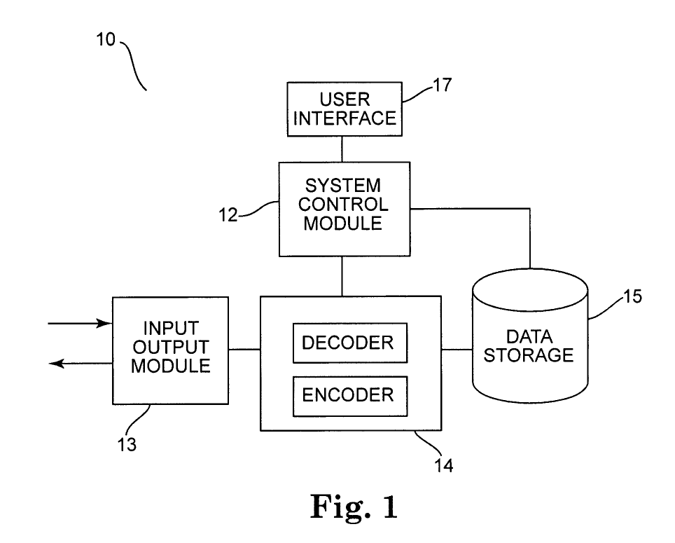

Referring now to FIG. 1, a dynamic disaster recovery system 10 is shown schematically. The system includes a number of cooperating sub-systems or modules including: a system control module 12; an input/output module 13; an encoder/decoder module 14; a data store 15 and a user interface 17.

Television data from a broadcast source (not shown) enters into the system at the input/output module 13 as raw data and is then routed into the encoder/decoder module 14. There the data is encoded into a suitable format which compresses the data into files or segments which are then stored in a data storage device 15. The encoding format is typically one for which public standards exists such as modified MPEG-2 but any number of other suitable encoding formats could be used, as long as they meet the system requirements of encoding speed, image quality and data compactness. The television data encoded includes audio as well as video data and further includes all extra information from the originating broadcast signal associated with the vertical blanking interval (VBI).

The data storage device 15 is preferably a magnetic hard disk drive of sufficient capacity and data transfer speed to handle the data flow requirements of the system. In one embodiment the data storage device can be a hard disk array or RAID (redundant array of independent disks) that can provide a higher level of operating performance and reliability. Although only one encoder is shown as a component of the encoder/decoder module 14, multiple boards operating in parallel can be used. In a preferred embodiment two encoder boards each capable of encoding two separate television data streams are employed giving the system a recording capacity of four independent television channels.

When system 10 is operating in a recording mode, encoded television data is continuously recorded onto storage device 15. The system initially generates a growing archive of broadcast material until a preset limit is reached whereupon subsequent encoded television data is recorded on top of the oldest data stored and thereby erasing it. The result is a dynamic archive of television material containing the most recent material broadcast.

The system control module 12 monitors the flow of data through the encoder/decoder module 14, organizes the storage of data within storage device 15 and manages the operational mode of the system with input from a human system operator through a user interface 17. The user interface may be affected through the Internet, intranet, or World Wide Web (WWW) enabling remote control and monitoring of the disaster recovery system 10.

If there is a failure of the broadcast system and subsequently a loss of input television data into the disaster recovery system 10, the control module 12 will effect a change of mode from recording television data to playing out television data stored on storage device 15 to the broadcast system. Encoded television data stored on storage device 15 will be sent to the encoder/decoder module, decoded, and transmitted to a transmission or uplink facility where it will be used as a broadcast signal to provide programming content until the time when the failure of the broadcast system is repaired and the original programming signal restored. At that point, system control module 12 will effect a change of mode back to encoding and recording television data onto storage device 15. In a preferred embodiment the encoder/decoder module contains two decoder cards, each capable of decoding one channel, thereby enabling the disaster recovery system to provide two channels worth of television content simultaneously.

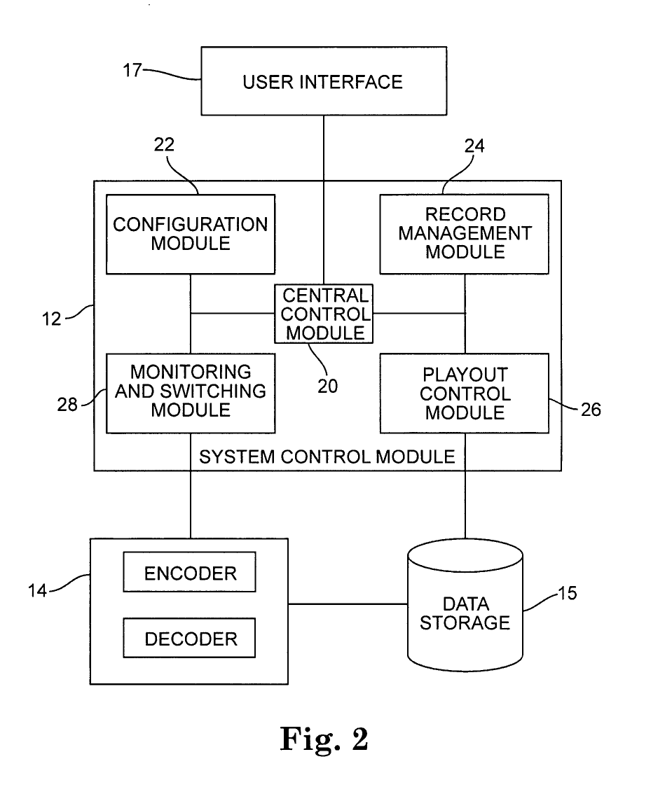

FIG. 2 shows the system control module 12 in more detail. A configuration module 22 is connected via a central control module 20 to a user interface 17. The configuration module 22 can be controlled by users to set the operating parameters of the system including the number of encoders and decoders active within the system, the number and location of data storage devices, the total amount of encoded material to be stored on the storage devices, and the parameters affecting television decoding and play-out such as at what point among the archived material to start play-out and the duration of a play-out cycle. Record management module 24 is connected via central control module 20 to monitoring and switching module 28 from which it receives metadata describing the television material being encoded by the encoder/decoder module 14. This metadata could include content description, time-code information or other data associated with the broadcast signal and is used to organize the storage of encoded television data. Additionally the metadata could include time-stamp data originating from the central control module 20.

Play-out control module 26 is activated by a signal from the central control module 20 and controls the flow of data from storage device 15 to encoder/decoder module 14. Concurrent to the activation of play-out control module 26, monitoring and switching module 20 is activated by central control module 20 that then switches the decoder to active status and the encoder to passive status.

While the system is encoding and recording data, the monitoring and switching module 28 transmits metadata to the record management module 24 and an operating status signal to central control module 20. If there is a failure of the broadcast system and television data is not being received and encoded by encoder/decoder module 14, the status signal received by central control will indicate the system failure and a message will be sent to the user interface 17 announcing the failure and prompting a switchover from recording mode to play-out mode. A user would then press or click a button on the interface to effect the switch over to decoding and play-out. In an alternative embodiment, a user could be monitoring the status of the broadcasting system by watching a video display of the broadcast programming and affecting the switchover when the failure of the programming signal is visually observed. In yet another embodiment, the central control module automatically effects a switchover when a failure status signal is received from the monitoring and switching module.

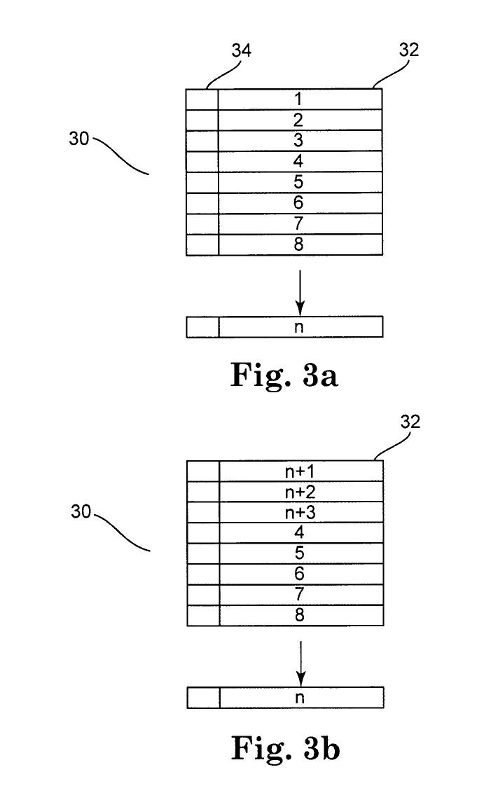

Turning now to FIG. 3a, the data structure 30 of encoded television data stored on storage device 15 is represented schematically. The data is an aggregation of individual segments 32, each of which is sequentially identified by metadata 34. The data represented is n segments arranged chronologically from 1 to n, with 1 representing the first data segment to be received and encoded and n representing the last segment to be received. The number of segments, n in this case, reflects the total amount of data storage specified by the configuration module that in turn was set by a user of the system through user interface 17. The data segments are shown as being of equal size, or duration, but this need not be the case. The data segments could be, for example, program content segments of 5-10 or more minutes duration or they could be individual advertisements of 30, 45 or 60 seconds duration. FIG. 3b illustrates the order in which individual data segments are replaced by newer data segments when the total storage limit of n has been surpassed and new segments are encoded and recorded.

When the system is switched from record to play-out mode, the play-out control module will indicate which data segment will be the first to be sent to the encode/decode module for decoding and play-out. If the system has been configured to play-out all the stored material starting from the oldest, the situation depicted in FIG. 3b would result in data segment 4 being sent first for decoding. This need not be the case, because the configuration module allows flexibility in the scheduling of the play-out material. For example, the system could be configured to start play-out at the start of the oldest completely stored program, or at the start of the first available advertisement prior to the start of the oldest completely stored program. Alternatively, the play-out can be configured relative in time to the failure of the broadcast signal, for example decoding and play-out could be configured to start with the segment recorded precisely 2 hours before the signal failure. Once activated the play-out can be configured to play-out for a preset duration of time or can be configured to play-out in a continuous loop until the problem from the originating broadcast site is resolved.

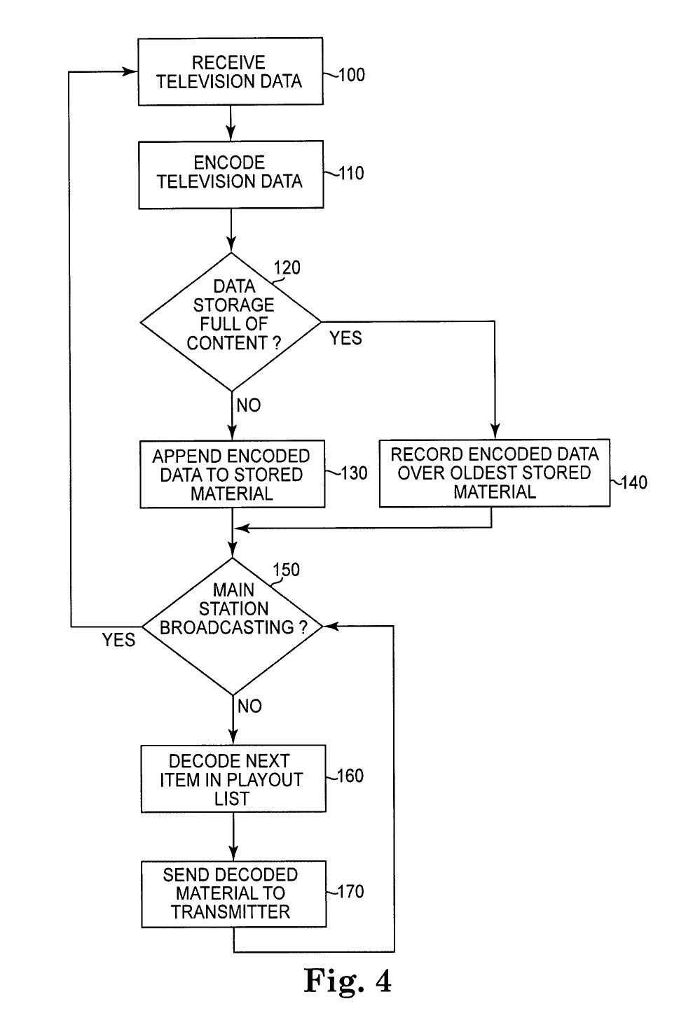

FIG. 4 is a simplified flow chart illustrating the main steps in both the recording and playout modes of the inventive method of providing back-up broadcasting means in the event of a failure at a main broadcasting facility. The method ensures that there is always sufficient recent content available which can be rebroadcast to satisfy the immediate needs of a broadcasting organization. The method further ensures that once activated the playout of the back-up content will continue with minimal human intervention until the problem at the main broadcasting facility is resolved.

In the method of FIG. 4, the system 10 receives television data 100 in the example through module 13 and then encodes the data 110 with module 14. If the data storage 15 is has not reached capacity with stored encoded programming 120, the module 12 causes the incoming programming to be appended to “the end” of the previously encoded and recording programming 130 on the storage 15. If at step 120, the data storage has reached capacity, the incoming programming is written over the oldest stored contents 140 on the storage 15. This continues as long as the main broadcast facility supplying the programming continues broadcasting 150. Once the main broadcast facility stops broadcasting, generally from a failure, the next item of programming, according to the playout list, is retrieved from storage 15 and decoded 160 with module 14. This decoded programming is then provided to a transmitter for broadcast 170. The system also checks to see whether the main broadcast facility is again operational, and continues to decode the next items on the playout list and transmit the decoded items until the main facility is operational.

What is claimed is:

1. A method for recovery of a broadcast source, the method comprising:
receiving television data from the broadcast source;
encoding the television data to create an encoded television data;
storing the encoded television data on a data storage, wherein the step of storing the encoded television includes appending the encoded television data to programs on the data storage if the data storage includes capacity to store the encoded television data, or overwriting an oldest program with the encoded television data if the data storage does not have capacity to append the encoded television data;
monitoring the broadcast source for a broadcasting failure;
continuing receiving television data, encoding the television data, and storing the encoded television data until the broadcasting failure is detected;
decoding a selected program on the data storage and broadcasting the selected program; and
continuing decoding and broadcasting selected programs on the data storage until the broadcasting failure at the broadcast source is repaired.

2. The method of claim 1 wherein the received television data is directly routed for encoding.

3. The method of claim 1 wherein encoding compresses the television data into one of files or segments for storing.

4. The method of claim 3 wherein encoding includes encoding in a public standard format.

5. The method of claim 4 wherein the format meets selected requirements for speed, image quality, and data compactness.

6. The method of claim 1 wherein the encoding includes simultaneous encoding a plurality of television data from multiple television data streams.

7. The method of claim 6 wherein the plurality of television data includes television data from four television channels.

8. The method of claim 1 wherein the storing is performed at times during the encoding.

9. The method of claim 8 wherein the decoding is performed at times exclusive of the encoding.

10. The method of claim 1 and further comprising receiving metadata corresponding to the television data, wherein the metadata is used to determine oldest program and the selected program.

11. The method of claim 10 and further comprising storing the metadata in a data structure exclusive of the data storage.

12. The method of claim 1 wherein the broadcast failure is detected automatically.

13. The method of claim 1 wherein broadcasting the decoded program includes providing the decoded program to a transmitter.

14. A system suitable for recovery of a broadcast source, the system comprising:
a data storage device;
an encoder/decoder module including encoder and decoder circuit boards and operably coupled to the data storage device, wherein the encoder/decoder module selectively receives and encodes television data into a selected format to create an encoded television data, and presents the encoded television data to the data storage device;
an interface for receiving selected inputs provided to the system including information related to the broadcast source regarding a broadcast failure;
a system controller operably coupled to the encoder/decoder module, the data storage device, and the interface, wherein the system controller monitors data flow through encoder/decoder module, organizes the storage of data within the storage device, and receives input from the interface;
wherein upon the broadcast failure the system controller effects a system mode change such that selected encoded television data on the storage device is decoded in the encoder/decoder for broadcast until the broadcast failure is repaired.

15. The system of claim 14 and further comprising an input/output module coupled to the encoder/decoder module for receiving the television data and outputting the decoded encoded television data.

16. The system of claim 14 wherein the system controller comprises a central control module operably, and the system controller further comprises a configuration module operably coupled to the central control module, a monitoring and switching module operably coupled to the encoder/decoder module and the central control module, a record management module operably coupled to the central control module, and a playout control module operably coupled to the data storage and the central control module.

17. The system of claim 14 wherein the interface provides an automatic signal to the system controller indicating a broadcast failure.

18. A system for use with recovering a broadcast source, the system comprising:
means for selectively receiving television data;
means for creating an encoded television data from the television data;
means for storing the encoded television data in a selected procedure;
means for detecting a broadcast failure of the broadcast source; and
means for outputting selected decoded television data until the failure of the broadcast failure is repaired.
